(19) United States
(12) Patent Application Publication
(10) Pub. No.: US 2007/0194885 A1
(43) Pub. Date: Aug. 23, 2007

(54) Electronic information label, electronic information label system and method of linking electronic information labels

(76) Inventors: Andreas Lindgren, Uppsala (SE); Masahiro Maeda, Osaka (JP); Bjorn Nilsson, Uppsala (SE); Par Rosander, Uppsala (SE)

Correspondence Address: YOUNG & THOMPSON, 745 SOUTH 23RD STREET, 2ND FLOOR, ARLINGTON, VA, 22202, US

(21) Appl. No.: 10/590,341

(22) PCT Filed: Feb. 23, 2005
(86) PCT No.: PCT/SE05/00259

§ 371 Date: Sep. 5, 2006

Related U.S. Application Data
(60) Provisional application No. 60/548,099, filed on Feb. 27, 2004.

(30) Foreign Application Priority Data
Feb. 27, 2004 (SE) 0400500-5
Mar. 5, 2004 (SE) 0400581-5

(51) Int. Cl. G05B 19/00

(52) U.S. Cl. 340/5.91; 705/20; 345/2.1

(57) ABSTRACT

Method of linking an electronic information label (EIL) having a display, to an Item in an EIL system including the steps: registering an EIL ID for the EIL, registering an ITEM ID for the Item to be linked with the EIL, storing the registered EIL ID and the ITEM ID as link data in a link data register in the EIL system, optionally indicating the link status for the EIL via a system interface, sending link confirmation data from the EIL system to the EIL, indicating, in response to the confirmation data, the link status for the EIL by displaying a link status image on the EIL display, wherein the link status image is at least partly a predefined image stored in an EIL storing unit.

The present invention relates to new method of linking electronic information labels in an EIL system, a new electronic information label, and a new electronic information label system, and in particular to efficient linking of electronic information labels to items, products or the like in such a system.

### BACKGROUND OF THE INVENTION

Electronic information labeling (EIL) systems in the form of electronic price labeling systems and the like are frequently used for displaying information in grocery shops and the like

An electronic price label, a server and a method for updating the price label is described in for example EP 0228377.

In an electronic price label system like this, information labels are attached to for example the shelves in the store or nearby a product bin. The price labels comprise components for wireless communication with a price data base. Each time there is a price change for a product this is communicated out to the price label for this product and the price shown on the display in the price label is changed. Normally LCDs are used as displays.

In US 2002/0020935 an electronic price label system is described where a dot matrix display is used in the price label. When a dot matrix display is used instead of a segment based display better resolution in the displayed image is achieved.

A problem with a wireless price label system using dot matrix displays is that the updating of the displays takes long time and a lot of power is required leading to a short lifetime. Price labels with low power consumptions are preferred.

In an EIL system each EIL must have an address for identification. Furthermore each EIL need to be linked to the Item (product) it is related to. The procedure of linking or relating an EIL with an Item is known as linking the Item to the EIL. Today it is common to provide each EIL with a sticker comprising the bar-code of the related Item.

EIL identification can be a printed bar-code, preferably attached on the backside of the EIL. Alternatively it can be a memory in the EIL that is accessible with a hand held device using wireless communication.

The Item identification can be a printed paper overlay that is attached to the label. For a common segment-based display showing only the price this paper overlay is needed for the customers to know what item the price is shown for. When linking off the Item from the EIL, this label must also be removed and a new one be attached for the new Item to be linked with said EIL.

A general method of linking an electronic information label (EIL) to an Item in an EIL system comprises the steps:
registering an EIL ID for the EIL,
registering an ITEM ID for the Item to be linked with said EIL,
storing the registered EIL ID and the ITEM ID as link data in a link data register in the EIL system,
indicating the link status for the EIL via a system interface,
sending link confirmation data from the EIL system to the EIL,
indicating, in response to the confirmation data, the link status for the EIL by displaying a link status image on the EIL display,

Preferably the linking process is relatively fast, as there normally are a very large number of merchandises that all have to be linked in order for the system to function properly. However when the EIL comprises a dot matrix display instead of a segment based display, the time needed to transmit the link confirmation data will be relatively long as it has to contain image data for the link status image.

It is very important to in a fast way see on the information display that it has been linked. For a dot matrix information display the updating time can in some cases take fairly long time (several seconds) before the display is updated with the link confirmation.

PCT/SE03/00336 shows one possible way to reduce the amount of data that has to be sent to an EIL in order to update the displayed image. In this system a main server is arranged to compare the updated image with the displayed image and only transmit the section of the display that has to be changed. This method works very well for updating already linked EILs with a new price or the like, but it does not apply to the link status image where essentially the whole display needs to be updated.

### SUMMARY OF THE INVENTION

The object of the invention is to provide a new method of linking electronic information labels in an EIL system, new electronic information labels, and a new electronic information label system, which method, labels, and system overcomes one or more drawbacks of the prior art. This is achieved by the method of linking an electronic information label, the electronic information labels and the electronic information label system as defined in the appended claims.

With this label, server and method a system is achieved where only a link confirmation data message is transmitted from the EIL server to the EIL to indicate the link status on the display of said EIL. Hence the link status procedure takes less time than if the whole display image should be sent. Hereby valuable time is saved during the linking process, and the label need to be turned on a less time thereby giving it a lower power consumption and longer battery life time.

The present invention provides link confirmation that always is a fast and secure message that disregards the update time required to update the ESL display. The use of predefined images for link confirmation will make the speed of linking labels to not rely on the update speed for the actual information display via the communication interface.

Another advantage is that the predefined images can be made different for products intended for different markets and different languages, while still being addressed by the same confirmation data or the like, whereby the system need not to be adapted to each specific market or language etc.

Still another advantage is that the EIL will provide rapid information of the link status by simply retrieving the link status image stored in an EIL storing means

### BRIEF DESCRIPTION OF THE DRAWINGS

The invention will be described in detail below with reference to the drawings, in which

FIG. 1 is a schematic view of an electronic information label.

FIG. 2 is a schematic view of a server adapted to communicate electronic information labels according to the invention.

FIG. 3 is a flowchart of one embodiment of a method according to the present invention

FIGS. 4a and 4b illustrate examples of link status images according to one embodiment of the present invention.

FIGS. 5a and 5b illustrate examples of link status images according to another embodiment of the present invention.

FIGS. 6a to 6c show a further embodiment the present invention.

FIG. 7 shows an example of a thin double sided display according to one embodiment of the present invention.

FIGS. 8a to 8d show an alternative embodiment of the present invention.

FIGS. 9a to 9c show an example of a display according to the present invention.

### DETAILED DESCRIPTION OF PREFERRED EMBODIMENTS

The electronic information label (EIL) according to the invention is a label showing different information of a product. Often, but not necessarily always, the price of the product is included in this information.

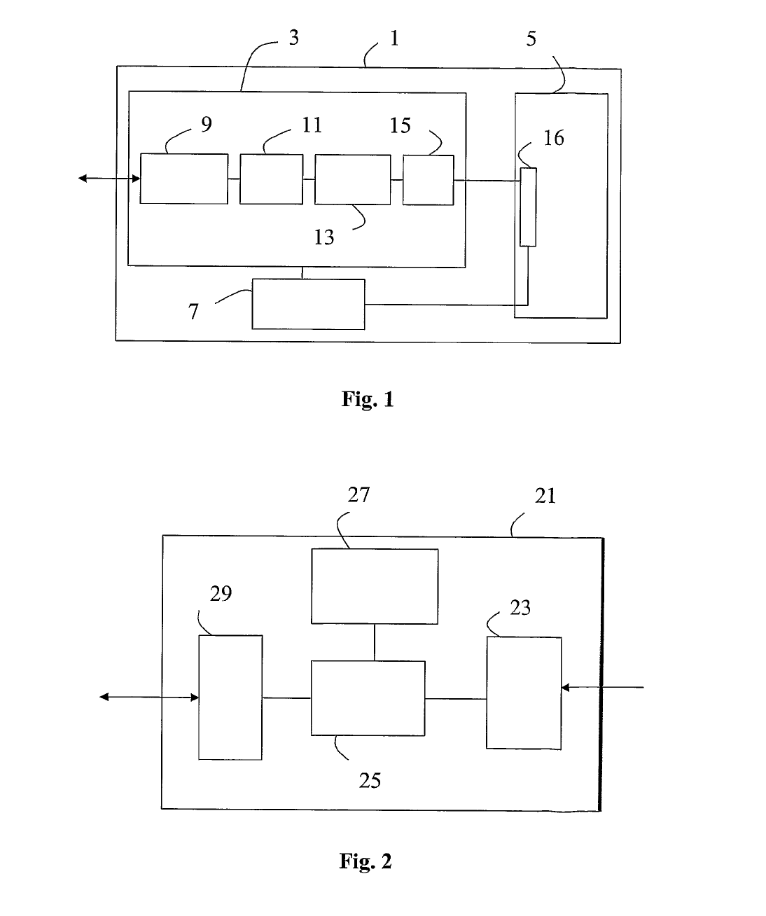

FIG. 1 is a schematic view of an EIL 1 according to the invention. It comprises a microprocessor 3, a display 5 connected to the microprocessor 3 and a power source 7 giving power to the microprocessor 3 and the display 5. The display 5 preferably comprises a display driver 16 that receives display signals from the microprocessor 3 and hence drives the display to show the appropriate image. Alternatively, the display driver 16 may be provided separately from the display 5 or be integrated in the microprocessor 3. In the EIL 1 according to the present invention, the display 5 is preferably of dot matrix type, but it may also be a segment display with a large number of segments. The microprocessor 3 comprises a communication interface 9 which is adapted to communicate, preferably wirelessly with a server in an EIL system. A wireless communication using for example IR or radio is preferred. The server is actually connected, wirelessly or via cable, to at least one transceiver that is adapted to receive and transmit data wirelessly to and from a plurality of EILs.

The microprocessor 3 further may comprise a processing means 11 connected to the communication interface 9, and a storing means 13 connected to the processing means 11. Furthermore the microprocessor 3 comprises a display updating means 15 connected to the storing means 13 and to the display driver 16 in the display 5. The display updating means is adapted to update the display 5 according to the content in the storing means 13 each time a change of its content occurs.

In a further embodiment of the invention the storing means comprises more than one display image. Different display images are stored giving the possibility to change image on the display. The EIL could be provided with a button or the like for the user to press for changing the display image. The store staff could for example need to see some other information about the product, such as storage status or other product related information.

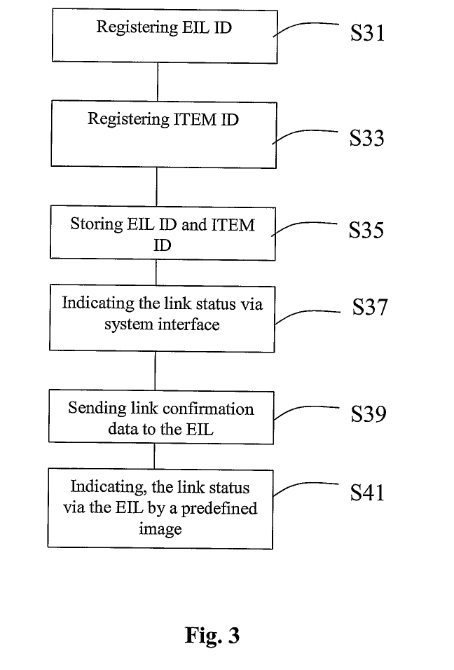

FIG. 2 is a schematic view of a server 21 adapted to communicate wirelessly, for example via IR or radio, with EILs according to the invention. The server is connected to for example a cash register and data bases comprising information that can be updated in the EILs. Normally the server is placed in a computer that also could comprise for example the cash register in a store. Price changes and other updated information are received in a receiving means 23 in the server 21 from for example a price data base. The server comprises also a processing means 25 adapted to process the received information. The processing means 25 comprises also a link register of which EILs that are linked to which items. The communication interface 29 is adapted to send updated information to the EIL having the address given by the processing means 25.

As disclosed in PCT/SE03/00336 the server may comprise storing means 27 that is used to store the images displayed on each EIL connected to the system.

During linked operation, the communication interface 9 is adapted to receive updated information from the server 21. The updated information is usually a new price for the product linked to this specific EIL but it could also be other kinds of product information that should be updated.

During the linking procedure, which is described in detail below, the communication interface 9 is adapted to receive link confirmation data from the EIL server.

FIG. 3 is a flowchart of one embodiment of a method of linking an electronic information label (EIL) to an Item in an EIL system, according to the invention. The different steps of the method are described below:

S31: Registering an EIL ID for the EIL. According to one embodiment the registering is performed using a barcode scanner for scanning an EIL identification bar code on the back of the EIL. As discussed above, the registration may further be performed by reading of identification data stored in memory in the EIL that is accessible with a registration device.

S33: Registering an ITEM ID for the Item to be linked with said EIL. According to one embodiment, the registering is performed using a barcode scanner to scan the bar code for the item. Alternatively the ITEM ID is looked up in an Item register.

S35: Storing the registered EIL ID and the ITEM ID as link data in a link data register 25 in the EIL system.

S37: Indicating the link status for the EIL via a system interface. The link status is e.g. displayed on a display as a text string, to confirm for the user that the correct link has been set up in the data register 25. This step is optional.

S39: Sending link confirmation data from the EIL system to the EIL. To check that the Item is linked to the correct EIL, a confirmation data message is sent from the EIL server to the EIL being linked to the Item.

S41: Indicating, in response to the confirmation data, the link status for the EIL by displaying a link status image on the EIL display wherein the link status image is at least partly a predefined image stored in an EIL storing means.

The EIL indicates by a message in the form of a link status image on the display that the linking process has been successful or not. Alternatively, if an error has been detected during the linking process, then the confirmation data may contain an error message, and the EIL may be arranged to display a link status image that indicates said error.

By predefining at least one link status image and storing it in the EIL storing means, the confirmation data transmitted from the EIL server need only to contain a short message that indicates to the EIL that the corresponding predefined link status image is to be read from the EIL storing means and displayed. Compared to the amount of data that has to be transferred to an EIL in order to update the whole display, the size of short message indicating that the predefined link status image is to be displayed is negligible. One specific situation when the benefits from the present invention become obvious, involves indicating link status in an Asian writing, where the complex signs indicating the status can be stored as one or more predefined images and thus be read in response to the confirmation data. Accordingly, the predefined images may be adapted to the language of the local market but still addressed using the same confirmation data from the server, thus without affecting the system communication.

According to another embodiment, the present invention provides an EIL that is arranged to indicate the link status for the EIL by displaying a link status image on the EIL display in response to link confirmation data, which EIL comprises EIL storing means for storing at least one at least partly predefined image to be displayed as link status image when linking the EIL to an Item.

According still another embodiment, the present invention provides an electronic information labeling system that comprises a plurality of EILs of the type described herein.

The EIL storing means may be configured to contain any suitable number of predefined link status images. In one embodiment the predefined images are permanently stored in the EIL storing means. In this case the information and layout of the images are defined once and for all when the EIL storing means are initiated during the production process. Alternatively, the information and layout of the predefined images can be altered via the EIL server or any other suitable interface, whereby the images may be adapted to certain applications, languages or the like.

In one embodiment of the invention, the processing means 11 is adapted to decompress the received updated information since in this embodiment the information was compressed in the server. Compression of the information would save sending and receiving capacities as well as battery lifetime.

As to the generation of an image adapted to be shown on the dot matrix display this could either be performed in the server using a layout script as will be described below or in the EIL itself. The updated information received in the server from a price data base comprises only text, for example as ASCII code, and need to be transferred to an image. If the image generation is performed in the EIL the processing means 11 performs this by using a layout script. An image is thus generated according to preset definitions in the layout script. These definitions typically relate to size and font of the text and to the positions in the display at which the various text parts should be located. This layout script can be updated from the server. Hereby it is possible to change the layout of the display images, for example size and font of the text, from the server.

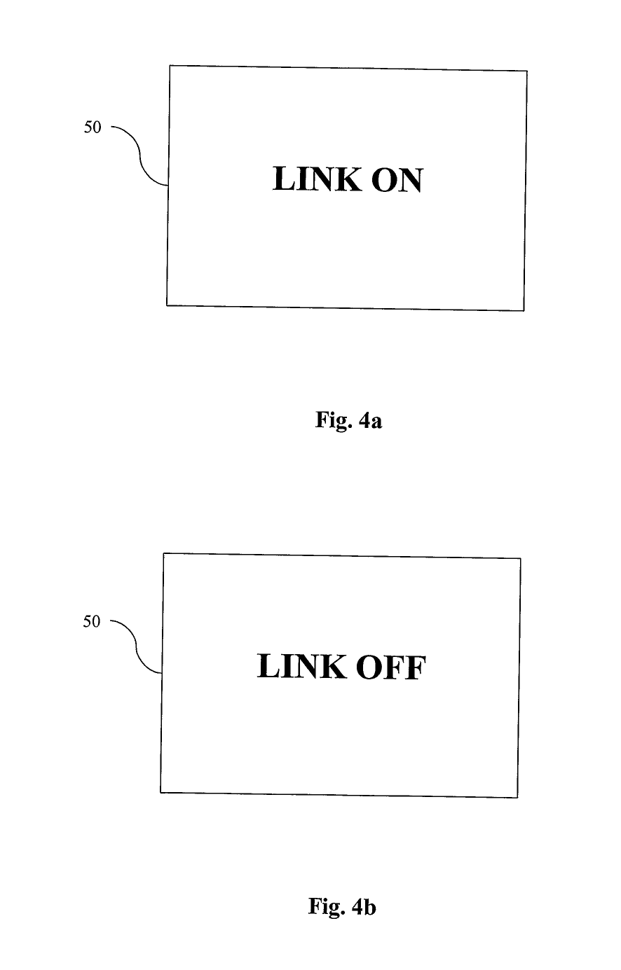

The method according to the present invention is, as is discussed above, used to set up a link between an Item and an EIL. However, the basic method can also be used to break a link between an EIL and an Item. When an EIL is linked to an item, its state is referred to as “LINK ON” and when it is not linked the state is “LINK OFF”. Therefore, when a link is set up, the confirmation data that is transmitted from the server to the EIL is a LINK ON command, and when a link is broken a LINK OFF command is transmitted. In response to the confirmation the EIL displays a predefined image 45 that indicates corresponding link status to the user as is illustrated in FIGS. 4a and 4b respectively.

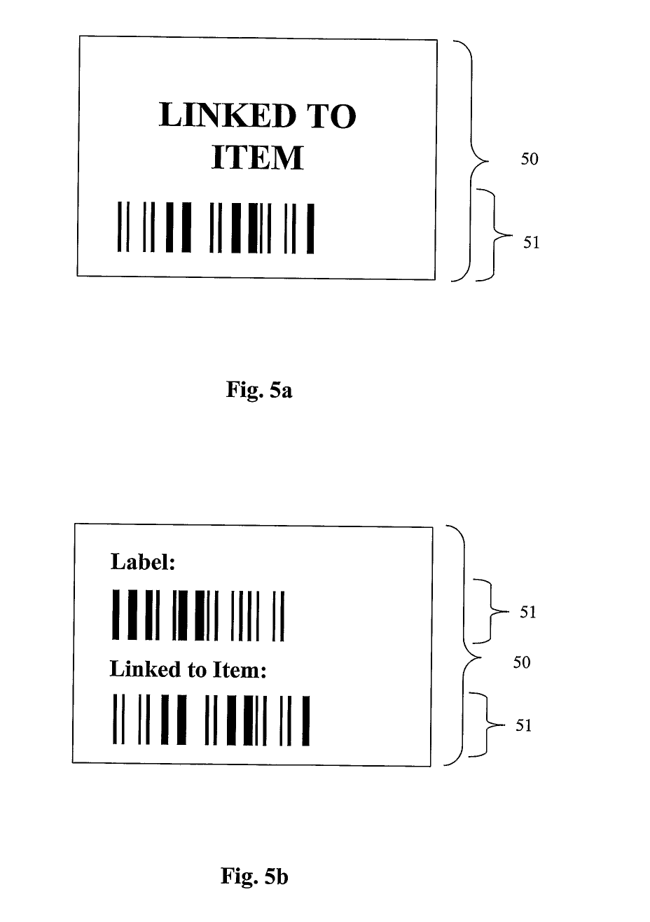

As is shown in FIGS. 5a and 5b, the link status image according to the present invention may be a predefined image 50 that may further comprise one or more sections 51 that need not to be predefined, which sections 51 may comprise link status specific data, comprised in the confirmation data or provided in other ways. The non predefined sections 51 may for instance comprise text or barcode information identifying the item to which the EIL is linked. To achieve this, the confirmation data e.g. may comprise data defining the barcode of the linked item. In one embodiment the confirmation data comprises the ITEM ID for the linked Item. The ITEM ID can be any data string that defines an Item, and in one embodiment it is corresponds to the Items barcode data. When comprised in the confirmation data, the barcode data may be in the form of a one dimensional data string and the EIL is preferably provided with means for transforming the data string into a graphical barcode that is displayed. In FIG. 5a the link status image comprises a barcode identifying the item to which the EIL is linked. In FIG. 5 the image also comprises a bar code identifying the EIL, which may be a non predefined section, but it is preferred that the EIL ID is stored in the EIL storing means and thus need not to be included in the confirmation data.

In one alternative embodiment, the confirmation data comprises the ITEM ID of the Item to which the EIL is linked, and the link status image is at least partly defined by the ITEM ID. As is mentioned above, the ITEM ID can represent the Items barcode, and thus the link status image may be represented as a bar code image.

The predefined image can further be stored as characters in the EIL storing means and the image to be presented is created in response to the confirmation data by use of a layout script that defines how the characters shall be built up on the display from the character identity. The layout script is preferably comprised in the display updating means 15 and makes the data handling in the EIL system even more efficient.

In many situations, it is desirable to check the link status of an EIL at a later point in time, but in order to save time and to avoid excessive transmission of information in the system, the EIL may be arranged to store the link status image in the EIL storing means, whereby it is accessible for confirmation of the link status at a later point in time. Preferably, the EIL storing means are arranged to store the link status image as long as said link is active.

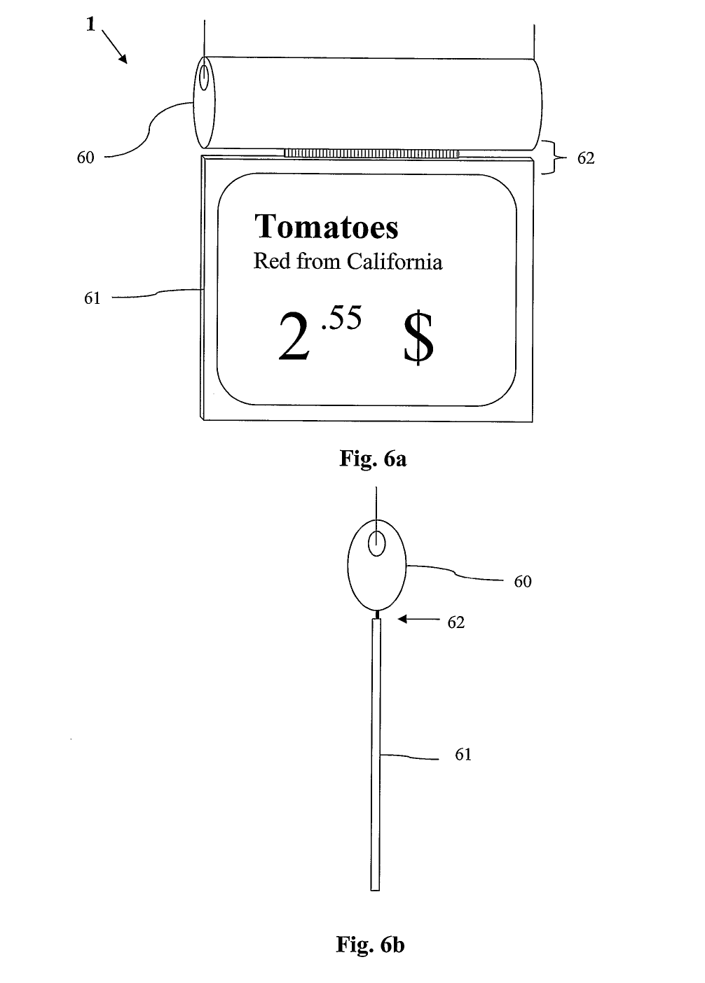

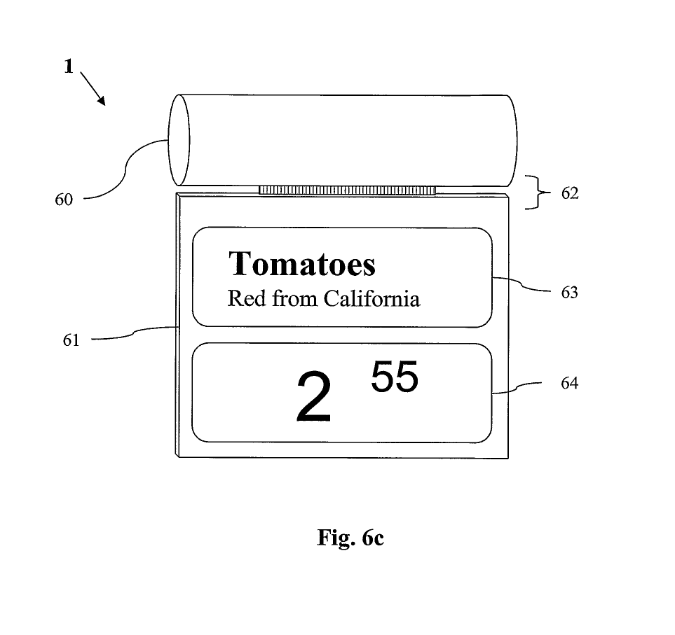

FIGS. 6a to 6c show a further embodiment the present invention that provides a modular electronic information label 1 comprising a display unit 61 and a control unit 60 wherein the display unit 61 is detachably attached to the control unit 60 via mating connection means 62. Such an EIL is advantageously used as a point of purchase (POP) label, for displaying the price of goods where ordinary shelf labels may not be appropriate, such as vegetables and the like. POP label are often arranged hanging from the ceiling or another elevated structure in a store

In many situations it is desirable to be able to change the size of the display for such POP label, even though the label e.g. remains in the same location and is linked to the same item. One apparent situation is to provide extra promotion for the linked item, whereby it is desirable to use a bigger display to draw attention to the item. As is mentioned above, the alternative is to provide a conventional EIL with a large display and to link that EIL to the Item, which of cause is a more time consuming process than changing the display. The same applies to the reverse process when changing back to normal size display.

As is shown in FIG. 6a the display may be a large dot matrix display 61, capable of reproducing high quality writing or images e.g. describing both the item and the price. However, it could just as well be a segment based display 64 that only shows the price, as is shown in FIG. 6c but in that case it is preferably combined with a passive display area 63 with a printed description of the Item attached thereto.

In order to be adaptive to different display types, the control unit preferably comprises display driving means adapted for driving displays of different types or sizes. Alternatively the display is provided with a general display interface and the control unit comprises display driving means capable of driving a display with the general display interface, whereby all types or sizes of displays behave essentially identical in the view of the display driving means. Today the display type is preferably selected from the list comprising: liquid crystal, electrochromic, electrophoretic, and electronic ink (E-paper) type displays of stiff or flexible type.

To achieve maximum flexibility all display units of different size or type are provided with the mating connection means, whereby they all can be connected to the standard size control unit.

Sometimes both sides of the EIL (back and front side) can be viewed by a customer or the like. In such situations it is preferred that the display is a double sided display on which information is presented on both sides. The information presented on the back can either be identical to the information on the front, or differ from the information on the front. When both sides of a double sided display are identical, the both sides can be connected to and driven by the same display driver in the control unit. If however, different information is to be displayed the two sides of the display, the control unit must be arranged to handle the two displays, and the displays must be separately connected to the display driver.

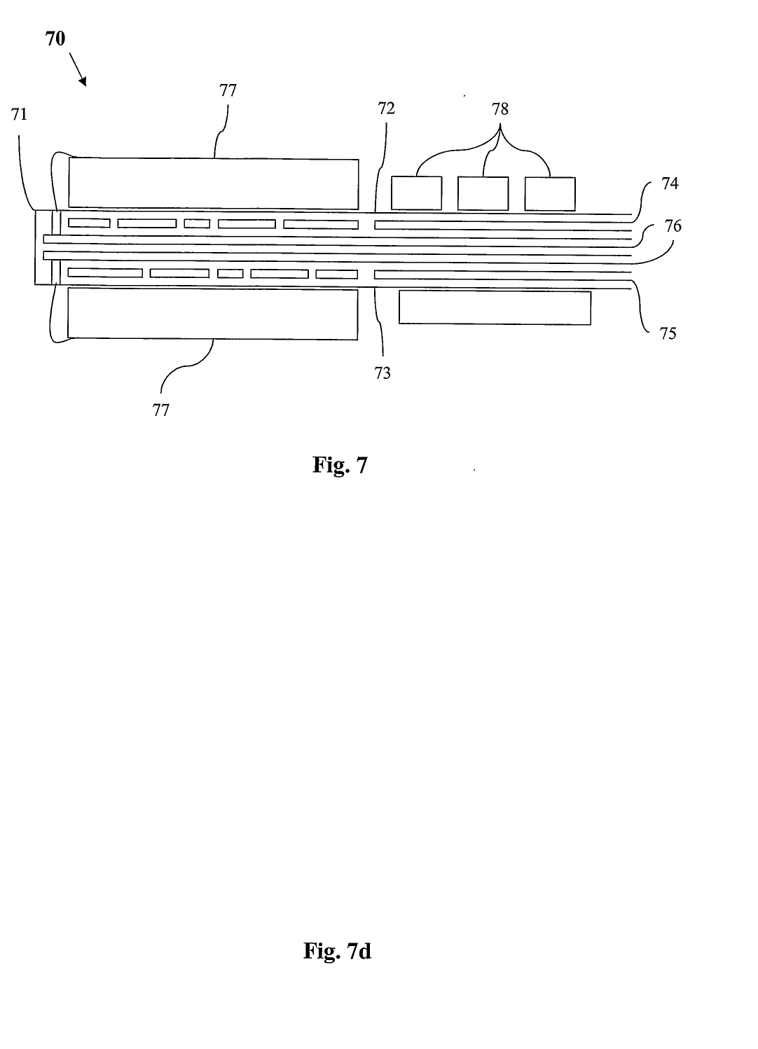

FIG. 7 shows an example of a thin double sided display 70 comprising
a circuit board 71 with a front surface 72, a back surface 73, a front electrode layer 74, a back electrode layer 75 and at least one intermediate earth electrode layer 76, the front electrode layer 74 and the back electrode layer 75 each being provided with an electrode pattern defining a display segment pattern,
at least one display module 77 arranged over and controlled by the display segment pattern on the front surface and the back surface respectively.

The circuit board is preferably a 3 or 4 layer PCB circuit board 71 or the like that is produced using standard techniques. This double sided display 70 can be made very thin and thus very light, which in many applications is desirable. Moreover the connection means 62 may be formed directly at one side of the circuit board 70, or electronic components 78 may be mounted directly on the board outside the display area. The double sided display of this type may be used to drive any type of display module 77, wherein the segments are controlled by applying an electrical field over the area of the segment, such as display modules 77 of LCD or electrophoretic (EPD) type, microcapsulated type EPDs are preferred. When using display modules comprised of plastic sheet material, the resulting display will be extremely thin, in the order of 2 to 3 mm thick in total.

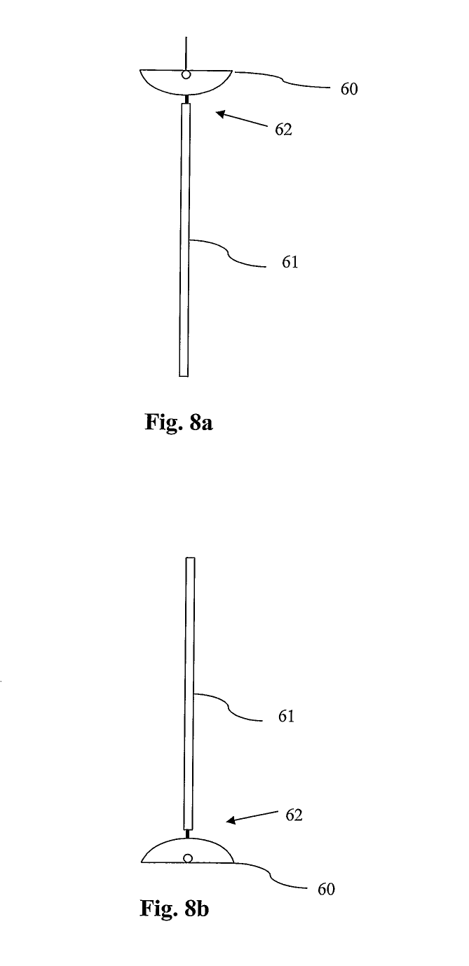

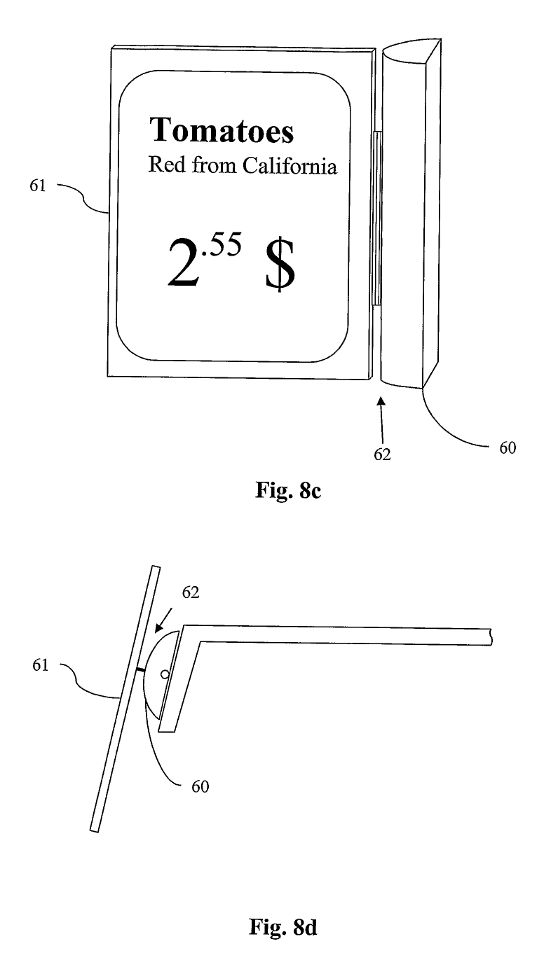

The modular EIL according to FIGS. 6a to 6c is shown as a free hanging point of purchase display that is fastened to the ceiling or the like with strings or the like. FIGS. 8a to 8d shows an alternative modular point of purchase (POP) display that can be used in a number of different orientations or applications, together with a number of different display units. FIG. 8a shows the POP display in a hanging mode. FIG. 8b shows the POP display in a standing mode. FIG. 8c shows the POP display in a side mounting mode, where the display is arranged to be fastened to a vertical post or the like. FIG. 8d shows how the POP display can be adapted to be mounted on an edge of a shelf or the like. The display unit for the embodiments shown in FIGS. 8a to 8c may either be the same, as long as the display driver has the capability to display the desired information in the correct orientation. In one embodiment the control unit automatically detects the correct orientation for the image to be displayed by a gravity sensor or the like. Moreover the display unit shown in FIG. 8d has the connection means arranged on the back surface to allow it to be connected to the control unit.

Another way to draw attention to an EIL or a POP type EIL, is to provide it with the possibility of actively altering the displayed image, such as a different color scheme or a flashing image. One effectful way of achieving this increased level of attention is to invert the displayed image. Preferably the display is repeatedly inverted whereby a flashing effect between the normal state and the inverted state is achieved.

Preferably the EIL comprises inverting means that enable switching between the two states as a response to a predefined signal or command. The inverting means are e.g. be comprised in the display updating means 15 in the microprocessor 3. Moreover the display updating means 15 may be arranged so that it activates repeated inversion (flashing) of the displayed image in response to a “display flash command” from the EIL server 21, and that the flashing of the display is performed until a “flash termination command” is received from the EIL server. Hence the EIL locally administers the flashing function in response to said signals, whereby the feature is realized using very little communication recourses.

An invertible display for use in EIL system provides the functionality to toggle between the normal and the inverted state. The actual state for a product can for instance be selected according to the status of the product. Normal sale price can be normal state and the inverted state can be used to indicate that a product is on sale. The state can also be selected based on the lighting conditions of the environment around the display.

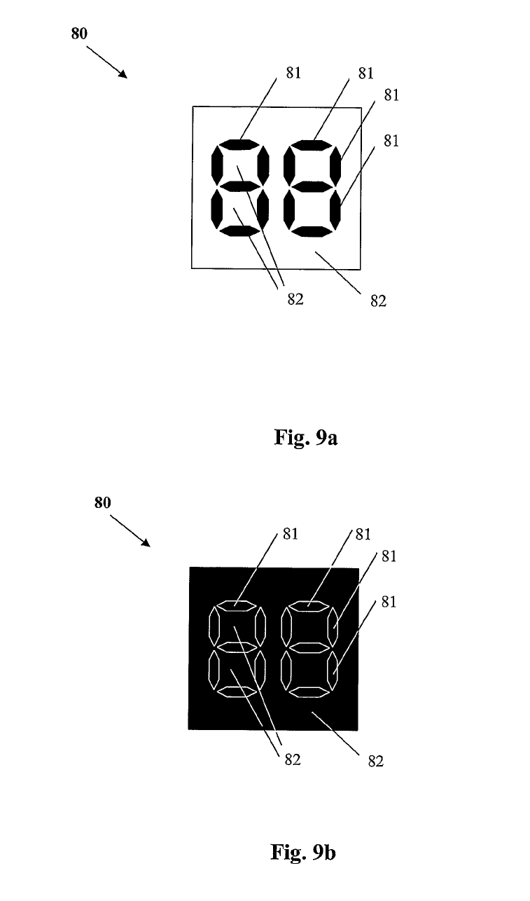

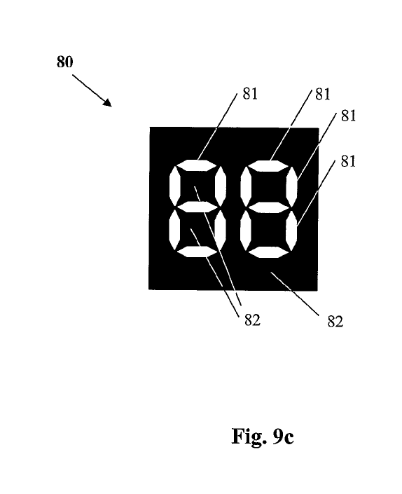

As the whole area of a dot matrix display can be controlled it automatically follows that an image displayed on a dot matrix display can be inverted, simply by changing the color state for all pixels. However, this it not the case with traditional segment based displays 80 as the one shown in FIG. 9a that only comprises electrode segments 81 defining the desired segments, which normally only covers a minor part of the image area, and not the background area 82 which is passive and not driven. The display shown in FIGS. 9b and 9c, however is an invertible display of segment type comprising background electrodes 82 covering the background areas, as is shown in FIG. 9b, which makes it possible to invert the image as is illustrated in FIG. 9c.

When this invertible display is formed using a unstable display module, such as a LCD module or similar, the inverted state will require more current compared with the normal state, as a much larger area has to be driven, since the current consumption is proportional to the segment area. However, the total energy consumption for the process of changing image is not adversely affected, whereby the inverted state can be used to create a flash effect that is affordable with respect to power consumption.

Use of a bistable display module, such as an electrophoretic display module (EPD, based on electrophoresis of charged pigment particles in a colored dielectric solvent), reduces the overall current consumption for displaying an inverted image since it will only require energy during the update procedure. However, the current consumption during the update procedure might be relatively high, whereby the use of a flash effect might be limited. Alternatively, a limited area of the display area might be used to draw attention to the EIL, e.g by flashing action or by providing such a limited area with a distinguishing color when in the colored state. By updating only a limited area of the bistable display area, the power consumption for the update is reduced and flashing of that area can be feasible. The provision of a limited area of distinguishing color might be realized by replacing a section or a limited area of the first bistable display module with a second display module having a distinguishing color in the colored state compared with the first module.

Of course other display technologies with active background will have the same possibility.

1. Method of linking an electronic information label (EIL) comprising a display, to an Item in an EIL system comprising the steps:
registering an EIL ID for the EIL,
registering an ITEM ID for the Item to be linked with said EIL,
storing the registered EIL ID and the ITEM ID as link data in a link data register in the EIL system,
optionally indicating the link status for the EIL via a system interface,
sending link confirmation data from the EIL system to the EIL,
indicating, in response to the confirmation data, the link status for the EIL by displaying a link status image on the EIL display,
characterized in that the link status image is at least partly a predefined image stored in an EIL storing means.

2. Method according to claim 1 characterized in that the predefined image is stored as characters in the EIL storing means and that the image to be presented is created in response to the confirmation data by use of a layout script that defines how the characters shall be built up on the display from the character identity.

3. Method according to claim 1 or 2 characterized in that the EIL display is a dot matrix type display.

4. Method according to any of the claims 1 to 3 characterized in that the confirmation data is a LINK ON or a LINK OFF command and the predefined images indicates corresponding link status to the user.

5. Method according to any of the claims 1 to 4 characterized in that the link status image comprises a barcode section intended for displaying a barcode.

6. Method according to claim 5 characterized in that the barcode section displays the barcode of the item to which the EIL is linked.

7. Method according to claim 6 characterized in that the confirmation data comprises ITEM ID data for the linked item.

8. Method according to claim 7 characterized in that the ITEM ID data corresponds to the barcode data of the Item.

9. Method according to claim 8 characterized in that the barcode data is a one dimensional data string and that the EIL is provided with means for transforming the data string into a graphical barcode that is displayed.

10. Method according to any of the claims 1 to 9 characterized in that the link status image is stored in the EIL storing means whereby it is accessible for confirmation of the link status at a later point in time.

11. Electronic information label (EIL) comprising a display, the EIL being arranged to indicate the link status for the EIL by displaying a link status image on the EIL display, in response to link confirmation data, characterized in that the EIL comprises EIL storing means for storing at least one at least partly predefined image to be displayed as link status image when linking the EIL to an Item.

12. Electronic information label according to claim 11 characterized in that the EIL storing means contains character information and that the EIL comprises layout script means that defines how characters shall be built up on the display from character information.

13. Electronic information label according to claim 11 or 12 characterized in that the EIL display is a dot matrix type display.

14. Electronic information label according to any of the claims 11 to 13 characterized in that the predefined images are arranged to indicate LINK ON or LINK OFF link status to the user.

15. Electronic information label according to any of the claims 11 to 14 characterized in that the link status image comprises a barcode section intended for displaying a barcode.

16. Electronic information label according to claim 15 characterized in that the barcode section displays the barcode of the item to which the EIL is linked.

17. Electronic information label according to claim 16 characterized in that the confirmation data comprises data defining the barcode of the linked item in the form of a one dimensional data string and that the EIL comprises with means for transforming the data string into a graphical barcode that is displayed.

18. Electronic information label according to any of the claims 11 to 17 characterized in that the EIL storing means are arranged to store the link status image as long as said link is active.

19. Electronic information label comprising a display unit and a control unit characterized in that the display unit is detachably attached to the control unit via mating connection means.

20. Electronic information label according to claim 19 characterized in that the control unit is provided with fastening means for attaching it at the “point of purchase”.

21. Electronic information label according to claim 19 or 20 characterized in that the control unit comprises display driving means adapted for driving displays of different types.

22. Electronic information label according to claim 19 or 20 characterized in that the display is provided with a general display interface and the control unit comprises display driving means capable of driving a display with the general display interface.

23. Electronic information label according any of the claims 19 to 22 characterized in that the display type is selected from the list comprising: liquid crystal, electrochromic, electrophoretic, and electronic ink type displays of stiff or flexible type.

24. Electronic information label according any of the claims 19 to 23 characterized in that the display unit can be selected from a variety of sizes, all provided with the mating connection means.

25. Electronic information label according any of the claims 19 to 24 characterized in that the display is a double sided display

26. Electronic information label according to claim 25 characterized in that the double sided display comprises
a circuit board with a front surface, a back surface, a front electrode layer, a back electrode layer and at least one intermediate earth electrode layer, the front electrode layer and the back electrode layer each being provided with an electrode pattern defining a display segment pattern,
at least one display module arranged over and controlled by the display segment pattern on the front surface and the back surface respectively.

27. Electronic information label according to claim 26 characterized in that the display modules are of LCD or EPD type.

28. Electronic information label according to claim 27 characterized in that the display modules are microcapsulate EPD modules.

29. Electronic information label according to any of the claims 25 to 28 characterized in that the display is arranged so that it is controlled as one single display that always displays identical information on both sides.

30. Electronic information label according to any of the claims 25 to 28 characterized in that the control unit is arranged to control the information on the two different sides of the display independently.

31. Electronic information label according any of the claims 19 to 30 characterized in that the control unit comprises a power source, communication means, display driving means capable of driving a display and display connection means for connecting a display to the control unit.

32. Electronic information label (EIL) comprising a display, the EIL being arranged to indicate the link status for the EIL by displaying a link status image on the EIL display, in response to link confirmation data, characterized in that the confirmation data comprises an ITEM ID of the Item to which the EIL is linked, and that the link status image is at least partly defined by the ITEM ID.

33. Electronic information label according to claim 32 characterized in that the EIL storing means contains character information and that the EIL comprises layout script means that defines how characters shall be built up on the display from character information.

34. Electronic information label according to claim 32 or 33 characterized in that the EIL display is a dot matrix type display.

35. Electronic information label according to any of the claims 32 to 34 characterized in that the ITEM ID data corresponds to the barcode of the Item.

36. Electronic information label according to claim 35 characterized in that the barcode data is a one dimensional data string and that the EIL is provided with means for transforming the data string into a graphical barcode that is displayed.

37. Electronic information label (EIL) comprising a display for displaying an image, and a display updating means (15), characterized in that the display is an invertible type display and that the display updating means is arranged to invert the displayed image.

38. Electronic information label according to claim 37 characterized in that the display updating means inverts the displayed image in response to a received display invert command.

39. Electronic information label according to claim 37 characterized in that the display updating means repeatedly inverts the displayed image in response to a received display flash command.

40. Electronic information label according to claim 37 characterized in that the display is a dot matrix display.

41. Electronic information label according to claim 37 characterized in that the display is an invertible segment display comprising a background segment.

42. Electronic information labeling system characterized in that it comprises a plurality of electronic information labels (EIL) according to any of the claims 11 to 41.

43. Method of linking an electronic information label (EIL) comprising a display, to an Item in an EIL system comprising the steps:
registering an EIL ID for the EIL,
registering an ITEM ID for the Item to be linked with said EIL,
storing the registered EIL ID and the ITEM ID as link data in a link data register in the EIL system,
optionally indicating the link status for the EIL via a system interface,
sending link confirmation data from the EIL system to the EIL,
indicating, in response to the confirmation data, the link status for the EIL by displaying a link status image on the EIL display,
characterized in that the confirmation data comprises the ITEM ID, and that the link status image is at least partly defined by the ITEM ID.

44. Method according to claim 43 characterized in that the ITEM ID data corresponds to the barcode of the Item.

45. Method according to claim 44 characterized in that the barcode data is a one dimensional data string and that the EIL is provided with means for transforming the data string into a graphical barcode that is displayed.

46. Double sided display characterized in that it comprises
a circuit board with a front surface, a back surface, a front electrode layer, a back electrode layer and at least one intermediate earth electrode layer, the front electrode layer and the back electrode layer each being provided with an electrode pattern defining a display segment pattern,
at least one display module arranged over and controlled by the display segment pattern on the front surface and the back surface respectively.

47. Double sided display according to claim 46 characterized in that the display modules are of LCD or EPD type.

48. Double sided display according to claim 47 characterized in that the display modules are microcapsulate EPD modules.
